(19) United States
(12) Patent Application Publication
(10) Pub. No.: US 2026/0358304 A1
(43) Pub. Date: Nov. 12, 2026

(54) LIQUID CHROMATOGRAPH SYSTEM AND CONTROL METHOD

(71) Applicant: SHIMADZU CORPORATION, Kyoto (JP)

(72) Inventors: Tomohiro SHAGAWA, Columbia, MD (US); Timothy LEE, Columbia, MD (US)

(73) Assignee: SHIMADZU CORPORATION, Kyoto (JP)

(21) Appl. No.: 19/475,500

(22) PCT Filed: Mar. 21, 2024
(86) PCT No.: PCT/JP2024/010997

§ 371 Date: Oct. 15, 2025

Related U.S. Application Data
(60) Provisional application No. 63/459,719, filed on Apr. 17, 2023.

(51) Int. Cl. G01N 30/32; B01D 15/10; B01D 15/16; G01N 30/02

(52) U.S. Cl. CPC G01N 30/32; B01D 15/102; B01D 15/163; G01N 2030/027; G01N 2030/326

(57) ABSTRACT

In a liquid chromatograph system, a control device, for a first idle period between a first analysis and a second analysis executed next to the first analysis among a plurality of analyses executed in a first stream, controls a first pump that supplies a mobile phase to the first stream to change from a first flow rate to a second flow rate when the first idle period is longer than an equilibration time required from a start of switching from the second flow rate to the first flow rate until the first flow rate is reached, and controls the first pump to maintain the first flow rate without changing to the second flow rate when the first idle period is shorter than the equilibration time.

### TECHNICAL FIELD

The present disclosure relates to a liquid chromatograph system having a plurality of streams and a control method for controlling the liquid chromatograph system.

### BACKGROUND ART

Liquid chromatography is a technique for separating components contained in a sample by introducing a sample to be analyzed into a column together with an eluent, which is a mobile phase. The components of the sample separated by the liquid chromatograph are analyzed by a detector such as a mass spectrometer.

International Publication No. WO 2017/216934 (Patent Literature 1) and “Nexera QX”, Shimadzu Corporation (Non-Patent Literature 1) disclose a liquid chromatograph system including a plurality of analytical lines (hereinafter referred to as streams) of a liquid chromatograph, an injection device for injecting a sample into each of the plurality of streams, a detector, and a valve for selectively connecting one of the plurality of streams to the detector.

### CITATION LIST

### Patent Literature

PATENT LITERATURE 1: International Publication No. WO 2017/216934

### Non-Patent Literature

NON-PATENT LITERATURE 1:“Nexera QX”, [online], [searched on December 14, 2022], Shimadzu Corporation, Internet <URL: https://www.ssi.shimadzu.com/products/liquid-chromatography-mass-spectrometry/ultrafast-multiplex-lcms-nexera-qx.html>

### SUMMARY OF INVENTION

### Technical Problem

According to the liquid chromatograph system described in Patent Literature 1 and Non-Patent Literature 1, analysis efficiency can be improved by using a plurality of streams, performing sample separation in parallel, and continuing mass spectrometry. However, in such a liquid chromatograph system, an idle period during which analysis is not performed in a stream may occur.

During the idle period, it is not necessary to flow the mobile phase, but it is preferable to keep the mobile phase flowing continuously to avoid damage to the pump and the like. On the other hand, if the mobile phase continues to flow at the same flow rate as during analysis, there is a problem that the consumption of the mobile phase becomes large.

There is also a method of lowering the flow rate during the idle period, but when the flow rate is lowered, it is necessary to raise the flow rate again at the start of analysis. However, when raising the flow rate, it is preferable to raise the flow rate stepwise in consideration of pump damage, and there is a problem that it takes time to restart the analysis.

An object of the present disclosure is to suppress pump damage and mobile phase consumption without reducing analysis efficiency in a liquid chromatograph system having a plurality of streams.

### Solution to Problem

A liquid chromatograph system of the present disclosure includes: a plurality of streams for separating components contained in a sample; a plurality of pumps for supplying a mobile phase to each of the plurality of streams; and a control device for controlling each apparatus to execute separation of the components in the sample using each of the plurality of streams in parallel. For each of the plurality of streams, the control device is capable of controlling each apparatus such that a plurality of analyses are executed at a first flow rate in a first stream of the plurality of streams, wherein one analysis is defined as a period from when a sample is injected into the one stream until the one stream is in a state where a next sample can be injected. For each of the plurality of streams, the control device is capable of controlling a pump that supplies the mobile phase to the stream such that a flow rate of the mobile phase supplied to the stream becomes a second flow rate lower than the first flow rate during an idle period in which no analysis is being performed. For a first idle period between a first analysis and a second analysis executed next to the first analysis among the plurality of analyses executed in the first stream, the control device controls a first pump that supplies the mobile phase to the first stream to change from the first flow rate to the second flow rate when the first idle period is longer than an equilibration time required from a start of switching from the second flow rate to the first flow rate until the first flow rate is reached, and controls the first pump to maintain the first flow rate without changing to the second flow rate when the first idle period is shorter than the equilibration time.

A control method of the present disclosure is a control method for controlling a liquid chromatograph system. The liquid chromatograph system includes a plurality of streams for separating components contained in a sample, and a plurality of pumps for supplying a mobile phase to each of the plurality of streams. The control method includes: a step of controlling each apparatus to execute separation of the components in the sample using each of the plurality of streams in parallel; a step of, for each of the plurality of streams, controlling each apparatus such that a plurality of analyses are executed at a first flow rate in a first stream of the plurality of streams, wherein one analysis is defined as a period from when a sample is injected into the one stream until the one stream is in a state where a next sample can be injected; a step of, for each of the plurality of streams, being able to control a pump that supplies the mobile phase to the stream such that a flow rate of the mobile phase supplied to the stream becomes a second flow rate lower than the first flow rate during an idle period in which no analysis is being performed; a step of determining whether a first idle period between a first analysis and a second analysis executed next to the first analysis among the plurality of analyses executed in the first stream is longer than an equilibration time required from a start of switching from the second flow rate to the first flow rate until the first flow rate is reached; a step of, when it is determined that the first idle period is longer than the equilibration time, controlling a first pump that supplies the mobile phase to the first stream to change from the first flow rate to the second flow rate; and a step of, when it is determined that the first idle period is shorter than the equilibration time, controlling the first pump to maintain the first flow rate without changing to the second flow rate.

### Advantageous Effects of Invention

According to the present disclosure, for the first idle period between the first analysis and the second analysis, the first pump is controlled according to whether the first idle period is longer than the equilibration time. Therefore, the flow rate can be lowered when it can be lowered without delaying the start timing of the second analysis, and pump damage and mobile phase consumption can be suppressed without reducing analysis efficiency.

### BRIEF DESCRIPTION OF DRAWINGS

FIG. 1 is a schematic configuration diagram of an LC system.

FIG. 2 is a schematic configuration diagram of a stream.

FIG. 3 is an example of a setting screen for an idle flow rate and an equilibration time.

FIG. 4 is a timing chart showing an analysis schedule and an example of pump control.

FIG. 5 is a timing chart showing an analysis schedule and an example of pump control when changed from the analysis schedule shown in FIG. 4.

FIG. 6 is a flowchart showing an example of processing executed by a processor 182.

FIG. 7 is a flowchart showing processing according to a modification.

FIG. 8 is an example of a setting screen for accepting a change in the number of streams.

### DESCRIPTION OF EMBODIMENTS

Hereinafter, embodiments of the present disclosure will be described in detail with reference to the drawings. In the drawings, the same or corresponding parts are denoted by the same reference numerals, and a description thereof will not be repeated.

### Overall Configuration of System

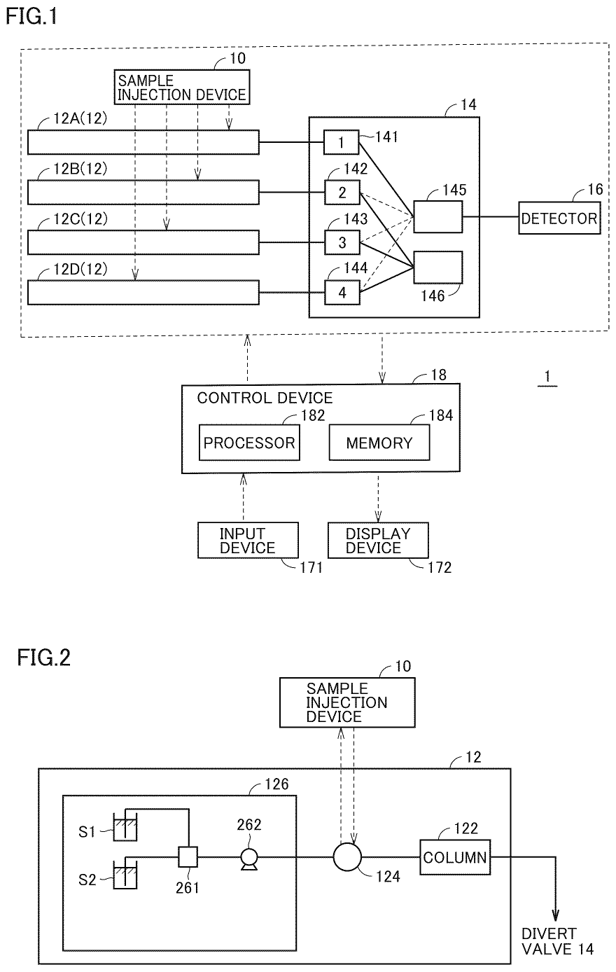

Referring to FIG. 1, a schematic configuration of a liquid chromatograph system (hereinafter LC (Liquid Chromatography) system) for which analysis conditions are set with the support of a support device according to the present embodiment will be described. FIG. 1 is a schematic configuration diagram of the LC system.

The LC system 1 separates and analyzes components contained in a sample. The LC system 1 includes a sample injection device 10, a plurality of streams 12A to 12D, a divert valve 14, and a detector 16. Hereinafter, when the streams 12A to 12D are not distinguished, they are referred to as “stream 12”.

The sample injection device 10 injects a sample into each of the plurality of streams 12A to 12D. The sample injection device 10 is, for example, an autosampler, and although not shown, includes one or more sample plates capable of accommodating samples and a needle. The sample injection device 10 typically includes a plurality of sample plates. The needle suctions a sample from a sample plate and injects the suctioned sample into a predetermined stream 12 according to set analysis conditions.

The stream 12 is an analysis flow path provided for separating components contained in a sample, and a mobile phase flows through it. Each of the streams 12A to 12D is connected to the detector 16 via the divert valve 14.

The divert valve 14 includes ports 141 to 146. The streams 12A to 12D are connected to the ports 141 to 144, respectively. The detector 16 is connected to the port 145. A waste liquid pipe (not shown) is connected to the port 146. The divert valve 14 switches the connection destination of each of the ports 141 to 144 to either the port 145 or the port 146, thereby fluidically connecting any one of the streams 12A to 12D to the detector 16.

The detector 16 is disposed downstream of the streams 12A to 12D and analyzes the components separated by passing through each of the streams 12A to 12D. In one embodiment, the detector 16 is a mass spectrometer. The detector 16 is not limited to a mass spectrometer and may be an absorbance detector, a fluorescence detector, a refractive index detector, an electrical conductivity detector, an evaporative light scattering detector, or the like, and is not particularly limited.

The control device 18 includes a processor 182 and a memory 184. The processor 182 is, for example, a CPU and is an arithmetic circuit that executes predetermined arithmetic processing described in a program. The memory 184 includes a non-volatile memory or a volatile memory such as a ROM (Read Only Memory) or a RAM (Random Access Memory), and/or a large-capacity storage device such as an HDD (Hard Disk Drive) or an SSD (Solid State Drive). The processor 182 reads out programs and data stored in the memory 184 to control the sample injection device 10, pumps, valves, and mixers included in the stream 12, the divert valve 14, and the detector 16, which constitute the LC system 1, and executes predetermined processing in response to detection results from the detector 16 and the operating status of each device.

An input device 171 and a display device 172 are connected to the control device 18. The input device 171 is, for example, a keyboard, a mouse, a pointing device, a touch panel, or the like, and accepts user operations. The display device 172 is, for example, a liquid crystal display (LCD) or an organic EL (Electro Luminescence) display. The control device 18 accepts user operations received via the input device 171. The control device 18 also outputs a video signal to the display device 172. The display device 172 displays an image corresponding to the video signal output from the control device 18.

As described above, in the LC system 1, a plurality of streams 12A to 12D are connected in parallel and connected to the detector 16 via the divert valve 14, so that separation of components in a sample using each of the streams 12A to 12D can be executed in parallel.

### Configuration of Stream

FIG. 2 is a schematic configuration diagram of a stream. The stream 12 includes a supply device 126, a valve 124, and a column 122. A mobile phase is sent from the supply device 126 toward the column 122, and the mobile phase passes through the column 122 and is sent to the divert valve 14.

The supply device 126 supplies the mobile phase flowing through the stream 12. The supply device 126 includes a plurality of solvent containers S1, S2, a mixer 261, and a mobile phase pump 262.

The plurality of solvent containers S1, S2 accommodate solvents. The types of solvents accommodated in the solvent containers S1, S2 may be different from each other or the same. In the present embodiment, they are described as being different.

The mixer 261 mixes the respective solvents supplied from the solvent containers S1, S2 at a predetermined ratio. The mixed liquid mixed by the mixer 261 is sent as a mobile phase toward the column 122 by the mobile phase pump 262. The predetermined ratio includes 0:100. The mixing ratio may be set to be constant during the analysis of the sample, or may be set to change over time during the analysis.

The mobile phase pump 262 sends the mixed liquid mixed by the mixer 261 as a mobile phase toward the valve 124.

The valve 124 switches a flow path connected to the supply device 126 between a flow path that passes through the sample injection device 10 and is connected to the column 122, and a flow path that does not pass through the sample injection device 10 and is connected to the column 122. If a flow path in which the supply device 126, the sample injection device 10, and the column 122 are connected in series in this order is referred to as an “injection flow path,” and a flow path that does not pass through the sample injection device 10 and in which the supply device 126 and the column 122 are connected in series in this order is referred to as a “direct flow path,” it can be said that the valve 124 performs switching between the injection flow path and the direct flow path.

The column 122 separates components contained in the sample injected from the sample injection device 10. The column 122 is packed with a stationary phase for separating the components contained in the sample.

As described above, the stream 12 is configured to separate the components contained in the sample injected from the sample injection device 10.

The configuration of the stream 12 shown in FIG. 2 is an example and is not particularly limited. For example, the stream 12 may further include a flow path for sending a washing solution. Further, the stream 12 may be configured to have one solvent container and to be able to send only one type of solvent without including the mixer 261.

The configurations of the streams 12A to 12D may be common to each other or different from each other. In the present embodiment, the configurations of the streams 12A to 12D are described as being common to each other.

When the configurations of the streams 12A to 12D are different from each other, each of the streams 12A to 12D may be configured to be switchable between the direct flow path and the injection flow path, and include the supply device 126 and at least one column 122.

The configurations of the respective supply devices 126 included in the streams 12A to 12D may be different from each other or common. By making the configurations of the respective supply devices 126 different from each other, the type of mobile phase can be changed. Further, by making the types of the mobile phase pumps 262 included in the respective supply devices 126 different from each other, the settable range of the flow rate and the types of usable columns 122 can be varied for each stream 12. Further, the types and/or number of the respective columns 122 included in the streams 12A to 12D may be varied. Further, the streams 12A to 12D may further include a column oven for maintaining the temperature of the column 122.

### Flow Rate Control during Idle Period

As described above, the LC system 1 can execute the separation of components in a sample using each of the streams 12A to 12D in parallel by connecting the plurality of streams 12A to 12D in parallel and connecting them to the detector 16. For example, the LC system 1 can enhance analysis efficiency by staggering the timing of injecting samples into the streams 12A to 12D, thereby executing the separation of components in the sample using each of the streams 12A to 12D in parallel, while switching the stream 12 connected to the detector 16 to continuously detect the components separated by the streams 12A to 12D.

In the LC system 1, analysis efficiency can be further improved by designing the analysis conditions so that the idle period during which analysis is not being performed in each stream 12 is shortened. In the present embodiment, the “idle period” includes the period from the end of one analysis in one stream 12 to the execution of the next analysis. Further, in the present embodiment, “one analysis in one stream 12” is defined as the period from when a sample is injected into the one stream 12 until the one stream 12 is in a state where the next sample can be injected.

During the idle period, it is not necessary to flow the mobile phase, but it is preferable to keep the mobile phase flowing continuously to avoid damage to the pump and the like. On the other hand, if the mobile phase continues to flow at the same flow rate as during analysis (hereinafter also referred to as “analysis flow rate Fₐ”), the consumption of the mobile phase becomes large. The control device 18 according to the present embodiment controls the pump during the idle period so that the flow rate of the mobile phase becomes an idle flow rate Fᵢ, which is lower than the analysis flow rate Fₐ. This can suppress the consumption of the mobile phase.

Further, when increasing the flow rate, the control device 18 controls the pump to increase the flow rate stepwise in order to suppress damage to the pump. Therefore, when restarting the analysis by increasing the flow rate from the idle flow rate Fᵢ to the analysis flow rate Fₐ, it is preferable to provide an equilibration time to increase the flow rate stepwise. The equilibration time is the time required from the start of switching from the idle flow rate Fᵢ to the analysis flow rate Fₐ until the analysis flow rate Fₐ is reached.

However, if the idle flow rate Fᵢ is lowered from the analysis flow rate Fₐ after finishing one analysis when the equilibration time is longer than the idle period, it takes more time to restart the next analysis compared to the case where the flow rate is not lowered, because an equilibration time is required before restarting the next analysis.

The control device 18 according to the present embodiment determines whether to lower the flow rate from the analysis flow rate Fₐ during analysis according to whether the idle period becomes longer or shorter than the equilibration time. This prevents the analysis start timing from being delayed and suppresses a decrease in analysis efficiency.

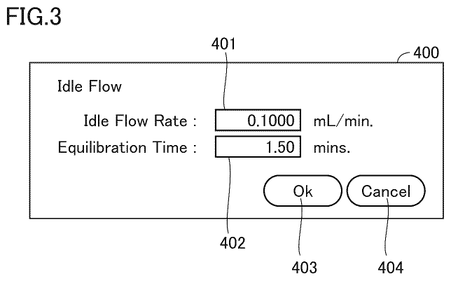

The idle flow rate Fᵢ and the equilibration time can be arbitrarily set by the user. FIG. 3 is an example of a setting screen for the idle flow rate and the equilibration time. A screen 400 is displayed on the display device 172. The screen 400 includes an input field 401 for the idle flow rate, an input field 402 for the equilibration time, an OK button 403, and a cancel button 404.

The user can input predetermined numerical values into the input field 401 and/or the input field 402 via the input device 171. Based on the fact that numerical values are input into the input field 401 and the input field 402 and the OK button 403 is operated, the processor 182 accepts the input of the idle flow rate Fᵢ and the equilibration time.

### Timing Chart

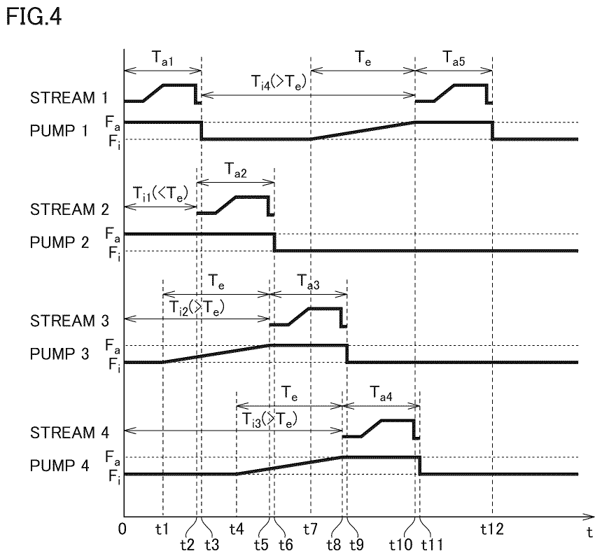

FIG. 4 is a timing chart showing an analysis schedule and an example of pump control. In FIG. 4, for each stream, the analysis schedule is shown in the upper row and an example of pump control is shown in the lower row.

In stream 1, a plurality of analyses are performed. Specifically, analysis 1 is performed in stream 1 during a period Tₐᵢ from 0 to timing t3, and analysis 5 is performed in stream 1 during a period Tₐ₅ from timing t10 to timing t12. A period Tᵢ₄ from timing t3 to timing t10 and the period after timing t12 are idle periods.

Since the period Tᵢ₄ is longer than the equilibration time Tₑ, the control device 18 controls the pump 1 of stream 1 to lower the flow rate from the analysis flow rate Fₐ to the idle flow rate Fᵢ after timing t3. The control device 18 controls the pump 1 so that the switching of the flow rate from the idle flow rate Fᵢ to the analysis flow rate Fₐ starts at timing t7 so that the switching is completed by timing t10 when analysis 5 can be started. The control device 18 controls the pump 1 of stream 1 to lower the flow rate from the analysis flow rate Fₐ to the idle flow rate Fᵢ after timing t12 when no analysis is performed.

In stream 2, analysis 2 is performed during a period Tₐ₂ from timing t2 to timing t6. A period Tᵢ₁ from 0 to timing t2 and the period after timing t6 are idle periods. Since the period Tᵢ₁ is shorter than the equilibration time Tₑ, the control device 18 controls the pump 2 of stream 2 so that the flow rate becomes the analysis flow rate Fₐ instead of the idle flow rate Fᵢ. The control device 18 controls the pump 1 of stream 1 to lower the flow rate from the analysis flow rate Fₐ to the idle flow rate Fᵢ after timing t6 when no analysis is performed.

In stream 3, analysis 3 is performed during a period Tₐ₃ from timing t5 to timing t9. A period Tᵢ₂ from 0 to timing t5 and the period after timing t9 are idle periods. Since the period Tᵢ₂ is longer than the equilibration time Tₑ, the control device 18 controls the pump 3 of stream 3 so that the flow rate becomes the idle flow rate Fᵢ. The control device 18 controls the pump 3 to start switching the flow rate from the idle flow rate Fᵢ to the analysis flow rate Fₐ at timing tl so that the flow rate becomes the analysis flow rate Fₐ by timing t5 when analysis 3 can be started. The control device 18 controls the pump 3 of stream 3 to lower the flow rate from the analysis flow rate Fₐ to the idle flow rate Fᵢ after timing t9 when no analysis is performed.

In stream 4, analysis 4 is performed during a period Tₐ₄ from timing t8 to timing t11. A period Tᵢ₃ from 0 to timing t8 and the period after timing t11 are idle periods. Since the period Tᵢ₃ is longer than the equilibration time Tₑ, the control device 18 controls the pump 4 of stream 4 so that the flow rate becomes the idle flow rate Fᵢ. The control device 18 controls the pump 4 to start switching the flow rate from the idle flow rate Fᵢ to the analysis flow rate Fₐ at timing t4 so that the flow rate becomes the analysis flow rate Fₐ by timing t8 when analysis 4 can be started. The control device 18 controls the pump 4 of stream 4 to lower the flow rate from the analysis flow rate Fₐ to the idle flow rate Fᵢ after timing t11 when no analysis is performed.

As described above, the control device 18 determines whether to lower the flow rate from the analysis flow rate Fₐ according to whether the idle period becomes longer or shorter than the equilibration time, and controls each pump according to the determination. Therefore, pump damage and mobile phase consumption can be suppressed without reducing analysis efficiency.

### Timing Chart when Analysis Schedule is Changed

The control device 18 can change the analysis schedule so that an analysis scheduled to be executed in one stream is executed in another stream. For example, when the control device 18 determines that one stream cannot be used, it changes the analysis schedule so that the analysis scheduled to be executed in that one stream is executed in another stream. Further, the control device 18 accepts a change in the number of streams to be used via the input device 171, and when the number of usable streams decreases, it changes the analysis schedule so that an analysis scheduled to be executed in one stream is executed in another analysis.

When the analysis schedule is changed so that an analysis scheduled to be executed in one stream is executed in another analysis, the number of analyses executed in one stream increases, and the idle period also becomes shorter. Therefore, the control device 18 may also change the control of the pump according to the shortening of the idle period.

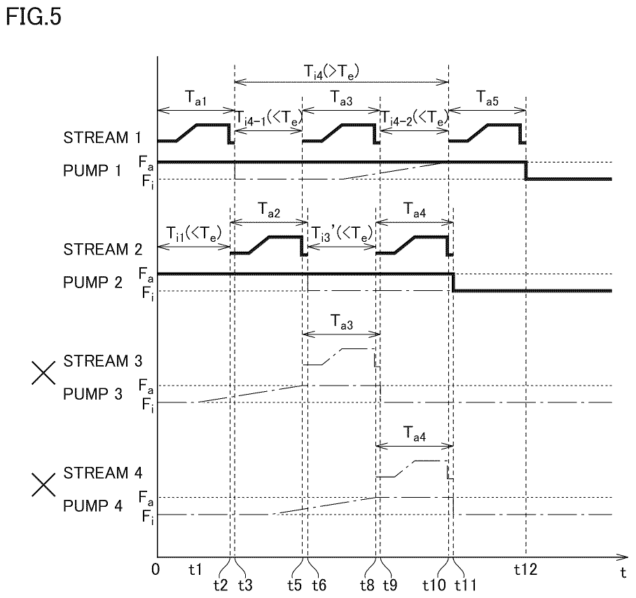

FIG. 5 is a timing chart showing an analysis schedule and an example of pump control when changed from the analysis schedule shown in FIG. 4. In the example shown in FIG. 4, it is assumed that among the streams 1 to 4 scheduled to be used, the control device 18 has changed the analysis schedule so that analyses 3 and 4 scheduled to be executed in streams 3 and 4 are executed in another stream 1 or 2.

The control device 18 changes the analysis schedule so that analysis 3, which was scheduled to be executed in stream 3, is executed in stream 1, and analysis 4, which was scheduled to be executed in stream 4, is executed in stream 2.

The analysis schedule is set such that analysis 3 is executed in stream 1 during a period Tₐ₃ from timing t5 to timing t9 between analysis 1 and analysis 5. By changing the analysis schedule to execute analysis 3 between analysis 1 and analysis 5, the idle period is divided from period Tᵢ₄ into period Tᵢ₄₋₁ and period Tᵢ₄₋₂, and becomes shorter. Since both period Tᵢ₄₋₁ and period Tᵢ₄₋₂ are shorter than the equilibration time Tₑ, the control device 18 controls the pump 1 of stream 1 so that the flow rate becomes the analysis flow rate Fₐ without changing the flow rate from the analysis flow rate Fₐ to the idle flow rate Fᵢ.

Before the analysis schedule change, the control device 18 was scheduled to control the pump 1 so that the flow rate would become the analysis flow rate Fₐ at timing t10 after temporarily lowering the flow rate from the analysis flow rate Fₐ to the idle flow rate Fᵢ between timing t3 and timing t10. After the analysis schedule change, the control device 18 controls the pump 1 so as not to change the flow rate between timing t3 and timing t10.

The analysis schedule is set such that analysis 4 is executed in stream 2 during a period Tₐ₄ from timing t8 to timing t11 after analysis 2. The period Tᵢ₃′ between analysis 2 and analysis 4 becomes an idle period. Since the period Tᵢ₃′ is shorter than the equilibration time Tₑ, the control device 18 controls the pump 2 of stream 2 so that the flow rate becomes the analysis flow rate Fₐ without changing the flow rate from the analysis flow rate Fₐ to the idle flow rate Fᵢ.

Due to the change in the analysis schedule, the control device 18 delays the timing of changing the flow rate from the analysis flow rate Fₐ to the idle flow rate Fᵢ in stream 2 from timing t6 to timing t11.

As described above, when the analysis schedule is changed so that an analysis scheduled to be executed in one stream is executed in another analysis, the number of analyses executed in one stream increases, and the idle period also becomes shorter. Therefore, the control device 18 also changes the control of the pump according to the shortening of the idle period.

### Flowchart

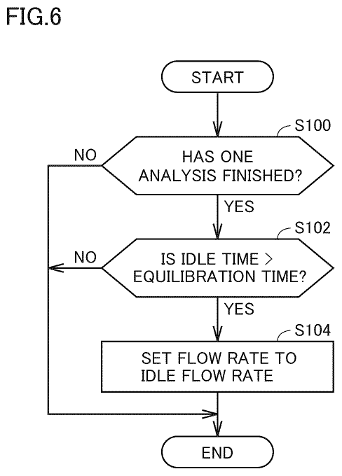

FIG. 6 is a flowchart showing an example of processing executed by the processor 182. The processor 182 executes the processing shown in FIG. 5 by reading and executing a program stored in the memory 184. The processor 182 executes the processing shown in FIG. 6 at a predetermined cycle.

In S100, the processor 182 determines whether one analysis has ended. Whether one analysis has ended is determined, for example, according to whether a predetermined analysis period has elapsed since a sample was injected by the sample injection device 10.

If it is determined that one analysis has not ended (NO in S100), the processor 182 ends the processing. If it is determined that one analysis has ended (YES in S100), the processor 182 proceeds to S102.

In S102, the processor 182 determines whether the idle period is longer than the equilibration time. More specifically, for the stream in which the analysis determined to have ended in S100 was performed, the processor 182 obtains the time until the start of the next analysis after that analysis (idle period), and determines whether the obtained idle period is longer than a predetermined equilibration time.

If it is determined that the idle period is not longer than the equilibration time (NO in S102), the processor 182 ends the processing without changing the flow rate, that is, keeping the flow rate at the analysis flow rate.

If it is determined that the idle period is longer than the equilibration time (YES in S102), the processor 182 sets the flow rate to the idle flow rate and ends the processing.

As described above, the processor 182 makes a determination of whether to set the idle flow rate each time one analysis is completed.

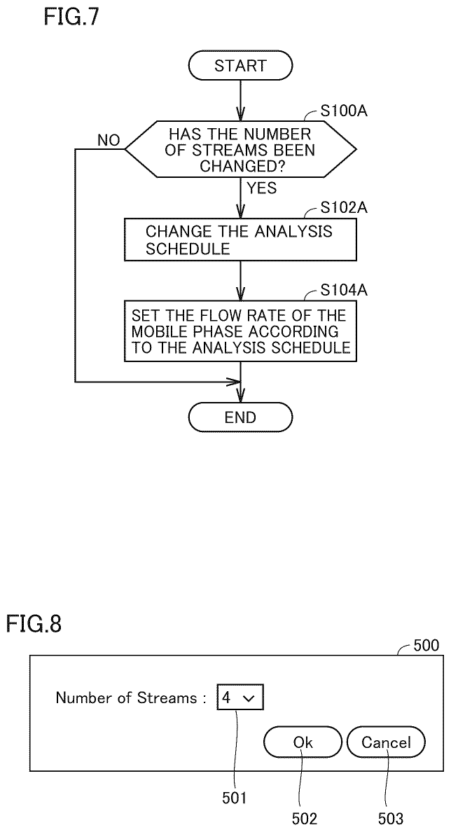

The processor 182 may set the flow rate in advance in accordance with the analysis schedule. An example of processing executed by the processor 182 in such a case will be described with reference to FIG. 7. FIG. 7 is a flowchart showing processing according to a modification. The processor 182 executes the processing shown in FIG. 7 by reading and executing a program stored in the memory 184. The processor 182 executes the processing shown in FIG. 7 at a predetermined cycle.

In S100A, the processor 182 determines whether the number of usable streams has been changed. As described above, when the processor 182 determines that one stream cannot be used, or when it accepts a change in the number of streams to be used via the input device 171, the processor 182 determines that the number of usable streams has been changed.

The change in the number of streams is accepted, for example, via the setting screen shown in FIG. 8. FIG. 8 is an example of a setting screen for accepting a change in the number of streams. A screen 500 is displayed on the display device 172. The screen 500 includes an input field 501 for the number of streams, an OK button 502, and a cancel button 503. The user inputs the number of streams to be used into the input field 501 via the input device 171. The input field corresponds to a reception unit that accepts a change in the number of streams. Based on the fact that a numerical value is input into the input field 501 and the OK button 502 is operated, the processor 182 accepts the change in the number of streams.

Returning to FIG. 7, if it is determined that the number of usable streams has not been changed (NO in S100A), the processor 182 ends the processing. If it is determined that the number of usable streams has been changed (YES in S100A), the processor 182 proceeds to S102A.

In S102A, the processor 182 changes the analysis schedule according to the changed number of streams. For example, when the number of usable streams has decreased, the processor 182 changes the analysis schedule so that an analysis scheduled to be executed in a certain stream is executed in another stream.

In S104A, the processor 182 resets the flow rate of the mobile phase according to the changed analysis schedule.

The processor 182 controls the pump included in each stream so that the flow rate of the mobile phase becomes the flow rate reset in S104A.

As described above, even when the processor 182 sets the flow rate control method in advance in accordance with the analysis schedule, it changes the flow rate control method in accordance with a change in the analysis schedule.

### Aspects

Those skilled in the art will understand that the above-described embodiments and modifications are specific examples of the following aspects.

(Aspect 1) A liquid chromatograph system according to one aspect includes a plurality of streams for separating components contained in a sample, a plurality of pumps for supplying a mobile phase to each of the plurality of streams, and a control device for controlling each apparatus to execute separation of the components in the sample using each of the plurality of streams in parallel. For each of the plurality of streams, the control device is capable of controlling each apparatus such that a plurality of analyses are executed at a first flow rate in a first stream of the plurality of streams, wherein one analysis is defined as a period from when a sample is injected into the one stream until the one stream is in a state where a next sample can be injected. For each of the plurality of streams, the control device is capable of controlling a pump that supplies the mobile phase to the stream such that a flow rate of the mobile phase supplied to the stream becomes a second flow rate lower than the first flow rate during an idle period in which no analysis is being performed. For a first idle period between a first analysis and a second analysis executed next to the first analysis among the plurality of analyses executed in the first stream, the control device controls a first pump that supplies the mobile phase to the first stream to change from the first flow rate to the second flow rate when the first idle period is longer than an equilibration time required from a start of switching from the second flow rate to the first flow rate until the first flow rate is reached, and controls the first pump to maintain the first flow rate without changing to the second flow rate when the first idle period is shorter than the equilibration time.

According to the liquid chromatograph system of Aspect 1, for the first idle period between the first analysis and the second analysis, the control device controls the first pump according to whether the first idle period is longer than the equilibration time. Therefore, the flow rate can be lowered when it can be lowered without delaying the start timing of the second analysis, and pump damage and mobile phase consumption can be suppressed without reducing analysis efficiency.

(Aspect 2) In the liquid chromatograph system according to Aspect 1, the control device is capable of changing the analysis schedule so that an analysis scheduled to be executed in a second stream of the plurality of streams is executed in the first stream. In the changed analysis schedule, the control device controls the first pump to change from the first flow rate to the second flow rate when the first idle period is longer than the equilibration time. In the changed analysis schedule, the control device controls the first pump to maintain the first flow rate without changing to the second flow rate when the first idle period is shorter than the equilibration time.

According to the liquid chromatograph system of Aspect 2, even when the analysis schedule is changed so that an analysis scheduled to be executed in the second stream is executed in the first stream and the first idle period is changed, the first pump is controlled according to the changed first idle period. Therefore, even when the analysis schedule is changed, pump damage and mobile phase consumption can be suppressed without reducing analysis efficiency.

(Aspect 3) In the liquid chromatograph system according to Aspect 2, when the control device determines that the second stream cannot be used, it changes the analysis schedule so that the analysis scheduled to be executed in the second stream is executed in the first stream.

According to the liquid chromatograph system of Aspect 3, since the analysis schedule is changed when it is determined that the second stream cannot be used, the analysis schedule can be changed flexibly. In addition, since the first pump is controlled according to the changed first idle period, pump damage and mobile phase consumption can be suppressed without reducing analysis efficiency while flexibly changing the analysis schedule.

(Aspect 4) The liquid chromatograph system according to Aspect 2 further includes a reception unit for accepting a change in the number of streams to be used. When the number of usable streams is reduced by the change accepted by the reception unit, the control device changes the analysis schedule so that the analysis scheduled to be executed in the second stream is executed in the first stream.

According to the liquid chromatograph system of Aspect 4, the number of streams to be used can be changed flexibly, and since the analysis schedule is changed according to the change and the first pump is controlled according to the changed first idle period, pump damage and mobile phase consumption can be suppressed without reducing analysis efficiency while flexibly changing the number of streams to be used.

(Aspect 5) In the liquid chromatograph system according to any one of Aspects 1 to 4, the control device determines whether the first idle period is longer than the equilibration time when the first analysis ends. The control device controls the first pump to change from the first flow rate to the second flow rate when the first idle period is longer than the equilibration time. The control device controls the first pump to maintain the first flow rate without changing to the second flow rate when the first idle period is shorter than the equilibration time.

According to the liquid chromatograph system of Aspect 5, since it is determined whether the first idle period is longer than the equilibration time when the first analysis ends, the pump can be controlled according to the latest analysis schedule at the time the first analysis ends.

(Aspect 6) A control method according to one aspect is a control method for controlling a liquid chromatograph system. The liquid chromatograph system includes a plurality of streams for separating components contained in a sample, and a plurality of pumps for supplying a mobile phase to each of the plurality of streams. The control method includes: a step of controlling each apparatus to execute separation of the components in the sample using each of the plurality of streams in parallel; a step of, for each of the plurality of streams, controlling each apparatus such that a plurality of analyses are executed at a first flow rate in a first stream of the plurality of streams, wherein one analysis is defined as a period from when a sample is injected into the one stream until the one stream is in a state where a next sample can be injected; a step of, for each of the plurality of streams, being able to control a pump that supplies the mobile phase to the stream such that a flow rate of the mobile phase supplied to the stream becomes a second flow rate lower than the first flow rate during an idle period in which no analysis is being performed; a step of determining whether a first idle period between a first analysis and a second analysis executed next to the first analysis among the plurality of analyses executed in the first stream is longer than an equilibration time required from a start of switching from the second flow rate to the first flow rate until the first flow rate is reached; a step of, when it is determined that the first idle period is longer than the equilibration time, controlling a first pump that supplies the mobile phase to the first stream to change from the first flow rate to the second flow rate; and a step of, when it is determined that the first idle period is shorter than the equilibration time, controlling the first pump to maintain the first flow rate without changing to the second flow rate.

(Aspect 7) A control program according to one aspect is a program for causing a computer to execute the control method according to Aspect 8.

(Aspect 8) A computer-readable medium according to one aspect stores the control program according to Aspect 7.

According to the control method, the control program, and the computer-readable medium of Aspects 6 to 8, for the first idle period between the first analysis and the second analysis, the first pump is controlled according to whether the first idle period is longer than the equilibration time. Therefore, the flow rate can be lowered when it can be lowered without delaying the start timing of the second analysis, and pump damage and mobile phase consumption can be suppressed without reducing analysis efficiency.

It is also contemplated that the embodiments disclosed herein can be appropriately combined within a technically consistent scope. The embodiments disclosed herein are to be considered in all respects as illustrative and not restrictive. The scope of the present invention is indicated by the claims rather than by the foregoing description of the embodiments, and all changes which come within the meaning and range of equivalency of the claims are intended to be embraced therein.

### REFERENCE SIGNS LIST

1 LC system, 10 Sample injection device, 12, 12A to 12D Stream, 14 Divert valve, 16 Detector, 18 Control device, 122 Column, 124 Valve, 126 Supply device, 141 to 146 Port, 171 Input device, 172 Display device, 182 Processor, 184 Memory, 261 Mixer, 262 Mobile phase pump, 400, 500 Screen, 401, 402, 501 Input field, 403, 502 OK button, 404, 503 Cancel button, Fₐ Analysis flow rate, Fᵢ Idle flow rate, S1, S2 Solvent container, Tₑ Equilibration time.

1. A liquid chromatograph system, comprising:
a plurality of streams for separating components contained in a sample;
a plurality of pumps for supplying a mobile phase to each of the plurality of streams; and
a control device for controlling each apparatus to execute separation of the components in the sample using each of the plurality of streams in parallel, wherein
the control device is configured to:
for each of the plurality of streams, control each apparatus such that a plurality of analyses are executed at a first flow rate in a first stream of the plurality of streams,
wherein one analysis is defined as a period from when a sample is injected into the one stream until the one stream is in a state where a next sample can be injected;
for each of the plurality of streams, control a pump that supplies the mobile phase to the stream such that a flow rate of the mobile phase supplied to the stream becomes a second flow rate lower than the first flow rate during an idle period in which no analysis is being performed; and
for a first idle period between a first analysis and a second analysis executed next to the first analysis among the plurality of analyses executed in the first stream,
control a first pump that supplies the mobile phase to the first stream to change from the first flow rate to the second flow rate when the first idle period is longer than an equilibration time required from a start of switching from the second flow rate to the first flow rate until the first flow rate is reached, and
control the first pump to maintain the first flow rate without changing to the second flow rate when the first idle period is shorter than the equilibration time.

2. The liquid chromatograph system according to claim 1, wherein the control device is configured to:
be capable of changing an analysis schedule so that an analysis scheduled to be executed in a second stream of the plurality of streams is executed in the first stream;
in the changed analysis schedule, control the first pump to change from the first flow rate to the second flow rate when the first idle period is longer than the equilibration time, and
in the changed analysis schedule, control the first pump to maintain the first flow rate without changing to the second flow rate when the first idle period is shorter than the equilibration time.

3. The liquid chromatograph system according to claim 2, wherein the control device is configured to, when it is determined that the second stream cannot be used, change the analysis schedule so that the analysis scheduled to be executed in the second stream is executed in the first stream.

4. The liquid chromatograph system according to claim 2, further comprising a reception unit for accepting a change in a number of streams to be used,
wherein the control device is configured to, when the number of usable streams is reduced by the change accepted by the reception unit, change the analysis schedule so that the analysis scheduled to be executed in the second stream is executed in the first stream.

5. The liquid chromatograph system according to claim 1, wherein the control device is configured to:
determine whether the first idle period is longer than the equilibration time when the first analysis ends;
control the first pump to change from the first flow rate to the second flow rate when the first idle period is longer than the equilibration time, and
control the first pump to maintain the first flow rate without changing to the second flow rate when the first idle period is shorter than the equilibration time.

6. A control method for controlling a liquid chromatograph system, the liquid chromatograph system including:
a plurality of streams for separating components contained in a sample, and a plurality of pumps for supplying a mobile phase to each of the plurality of streams, the control method comprising:
a step of controlling each apparatus to execute separation of the components in the sample using each of the plurality of streams in parallel;
a step of, for each of the plurality of streams, controlling each apparatus such that a plurality of analyses are executed at a first flow rate in a first stream of the plurality of streams, wherein one analysis is defined as a period from when a sample is injected into the one stream until the one stream is in a state where a next sample can be injected;
a step of, for each of the plurality of streams, being able to control a pump that supplies the mobile phase to the stream such that a flow rate of the mobile phase supplied to the stream becomes a second flow rate lower than the first flow rate during an idle period in which no analysis is being performed;
a step of determining whether a first idle period between a first analysis and a second analysis executed next to the first analysis among the plurality of analyses executed in the first stream is longer than an equilibration time required from a start of switching from the second flow rate to the first flow rate until the first flow rate is reached;
a step of, when it is determined that the first idle period is longer than the equilibration time, controlling a first pump that supplies the mobile phase to the first stream to change from the first flow rate to the second flow rate; and
a step of, when it is determined that the first idle period is shorter than the equilibration time, controlling the first pump to maintain the first flow rate without changing to the second flow rate.
